(19) United States
(12) Patent Application Publication
(10) Pub. No.: US 2009/0010580 A1
(43) Pub. Date: Jan. 8, 2009

(54) SPHERICAL PLAIN BEARING WITH SPREAD SEALING MEANS

(75) Inventors: Brian Gaumer, Watertown, CT (US); Robert Lugosi, Oxford, CT (US); James Voisine, Bristol, CT (US)

Correspondence Address: MICHAUD-DUFFY GROUP LLP, 306 INDUSTRIAL PARK ROAD, SUITE 206, MIDDLETOWN, CT, 06457, US

(73) Assignee: ROLLER BEARING COMPANY OF AMERICA, INC., Oxford, CT (US)

(21) Appl. No.: 12/144,140

(22) Filed: Jun. 23, 2008

Related U.S. Application Data
(63) Continuation-in-part of application No. 11/880,138, filed on Jul. 19, 2007.
(60) Provisional application No. 60/832,054, filed on Jul. 19, 2006.

(51) Int. Cl. F16C 33/10; F16C 11/06

(52) U.S. Cl. 384/322; 403/38

(57) ABSTRACT

A spherical plain bearing having dual sealing capability includes an outer race bearing member having an outer ring and an inner race bearing member having an inner ring, the inner ring being located within an opening defined by the outer ring. The opening is defined in part by two generally opposed peripheral edges with a spherical concave bearing surface extending therebetween. The inner ring defines a bore extending therethrough and a spherical convex bearing surface engagable with the concave bearing surface defined by the outer ring. A first ring seal is positioned in a first seal groove defined by the outer ring and is inboard of a first face surface defined by the outer ring. The outer and inner rings, or at least portions thereof, are heat treated using one of carburizing, nitriding, or nitrocarburizing.

### CROSS REFERENCE TO RELATED APPLICATION

This application is a continuation-in-part application of U.S. Ser. No. 11/880,138, filed Jul. 19, 2007, which claims the benefit of U.S. provisional application No. 60/832,054 filed Jul. 19, 2006, which is incorporated herein by reference in its entirety.

### TECHNICAL FIELD

This invention relates to spherical plain bearings and, more particularly, to a spherical plain bearing having spread sealing members.

### BACKGROUND OF THE INVENTION

Spherical plain bearings generally include inner and outer ring members wherein the outer ring member has a spherical concave interior surface that defines a cavity therein and wherein the inner ring member is disposed in the cavity and has a spherical convex surface that is complementary to, and is dimensioned to match, the interior concave surface of the outer ring member. In the assembled bearings, the concave and convex surfaces slide over each other to define the bearing surfaces or “load zone.”

A lubricant may be provided in the load zone of the bearing to minimize wear and to enhance rotational characteristics. In some spherical plain bearings, a lubrication groove may be provided in one of the sliding surfaces. The lubrication groove is a recess from the sliding surface within which a reserve of lubricant can be disposed. The recess is open to the other sliding surface, which can be contacted by the lubricant. As the second surface slides over the first, lubricant is carried between the sliding surfaces to lubricate the bearing. A conventional lubrication groove has sharp edges at the sliding surface of the ring member on which is it formed. The sharp edges tend to wipe lubricant from the surface as one ring member moves relative to the other ring member, thus inhibiting lubricant from lubricating the bearing.

Also in some spherical plain bearings, seals may be incorporated in an attempt to retain the lubricant in the load zone and to prevent or at least limit the flow of lubricant from the load zone. These configurations have a natural tendency to be easily removed after wear has occurred (either inadvertently or intentionally) or to be difficult to position in place initially. Furthermore, these sealing members are often undesirably located on the edges of the ring members of the bearings and adjacent to the contact surfaces of the load zone. When located on the edges of the ring members and adjacent to the contact surfaces of the load zone, the sealing members are easily damaged and/or dislodged, which makes it harder to maintain the seal to retain the lubricant in the load zone. Furthermore, the wiping function of the seal (ability to spread the lubricant on the bearing surface proximate the area at which the seal contacts the bearing surface) may be compromised.

### SUMMARY OF THE INVENTION

In one aspect, the present invention resides in a spherical plain bearing with dual sealing capability. As used herein, the term “dual sealing capability” means that one sealing member provides two sealing surfaces. The bearing in this aspect of the present invention includes an outer race bearing member having an outer ring and an inner race bearing member having an inner ring, the inner ring being located within an opening defined by the outer ring. The opening is defined in part by two generally opposed peripheral edges with a spherical concave bearing surface extending therebetween. The inner ring defines a bore extending therethrough and a spherical convex bearing surface engagable with the concave bearing surface defined by the outer ring. When assembled, the outer spherical convex bearing surface is located in interfacial sliding engagement with the inner spherical concave bearing surface. The inner ring and the outer ring are through hardened. A first ring seal is positioned in a first seal groove defined by the outer ring. The first seal groove, and thereby the first ring seal, is positioned inboard of a first face surface defined by the outer ring. A second ring seal is positioned in a second seal groove, generally opposite the first seal groove and positioned inboard of the second seal face. The first and second ring seals each have first and second lips that are connected together to form a substantially v-shaped cross-sectional geometry. Each of the first and second lips provides a seal, thereby allowing the bearing to exhibit the dual sealing capability. The outer and inner rings are case hardened.

In another aspect of the present invention, the above-described bore includes a pair of ring seals positioned therein and located generally opposite one another. The pair of ring seals is configured in the same manner as the above-described first and second ring seals with each having a first and second lip. During operation, the pairs of ring seals engage a shaft portion positioned in the bore.

One advantage of the present invention is that an effective sealing and wiping of a bearing surface is realized even after extended bearing use. This is achievable due to the flexibility and cross-sectional geometry of the first and second ring seals. Because of the flexible resilience of the material from which the sealing member is formed in conjunction with a v-shaped cross-sectional geometry defined by the first and second lips, wear occurs substantially evenly on the first and second lips of the sealing member without detrimentally effecting sealing and wiping abilities. In particular, the spreading and compression of the sealing member enhances the sealing communication with the bearing surface and at the same time allows wear to occur while still maintaining the seal. The lips of the sealing member are flexed outward less as they wear. Thus, tolerances in the bearing are taken up by the seal, thereby providing a self-adjusting characteristic not present in constructions heretofore.

Another advantage of the present invention is that there are two lips in each sealing member to provide the dual sealing function to the bearing. This dual sealing provides enhanced lubrication, minimizes contamination of the bearing, and at the same time provides a self-adjusting characteristic not present in bearings having sealing members having only a single lip. In addition, the sealing members of the present invention permit the collection of lubricant therein, and the lubricant itself serves as a barrier to the introduction of contaminants (such as environmental dirt or other particulates) into the load zone of the bearing.

Another advantage is that the dual sealing configuration of the present invention allows for the possibility of flushing degraded or contaminated lubricant out of the load zone by forcing fresh lubricant into the sealing member via a lubricant aperture. Adequate flushing pressure will allow the fresh lubricant to drive unwanted lubricant past the outer lip of the sealing member, and the seal will retain the fresh lubricant in the load zone once the flushing pressure is removed.

Still another advantage of the present invention derives from the heat treatment of the inner and outer rings. The increased hardness of the rings, particularly at the above-described concave and convex surfaces, increases the durability of the bearing.

### BRIEF DESCRIPTION OF THE DRAWINGS

FIG. 1 is a cross-sectional side view of a spherical plain bearing, of the present invention.

FIG. 2 is a cross-sectional side view of a sealing member located between the inner and outer races of the bearing of FIG. 1.

FIG. 3 is a cross-sectional side view of the insertion of the sealing member of the bearing of FIG. 1 into a seal mounting groove of the outer race.

FIG. 4 is an alternate embodiment of a sealing member of the present invention.

FIG. 5 is another alternate embodiment of a sealing member of the present invention.

FIG. 6 is another alternate embodiment of a sealing member of the present invention.

FIG. 7 is another alternate embodiment of a sealing member of the present invention.

FIG. 8 is another alternate embodiment of a sealing member of the present invention.

FIG. 9 is another alternate embodiment of a sealing member of the present invention.

FIG. 10 is a cross-sectional side view of a bearing assembly, of the present invention, having a first sealing member located between the inner and outer races and a second sealing member located between the inner race and a member operably located in the inner race.

FIG. 11 is a cross-sectional side view of the second sealing member of FIG. 10.

FIG. 12 is a schematic partial cross-sectional view of a one embodiment of a spherical plain bearing.

FIG. 13 is a schematic cross-sectional view part of a spherical plain bearing member having a lubrication groove with sharp edges.

FIG. 14 is a schematic cross-sectional view part of a spherical plain bearing member having a lubrication groove with a contoured side.

FIG. 15 and FIG. 16 both are schematic cross-sectional views of part of a spherical plain bearing having a contoured lubrication groove.

### DETAILED DESCRIPTION OF THE INVENTION

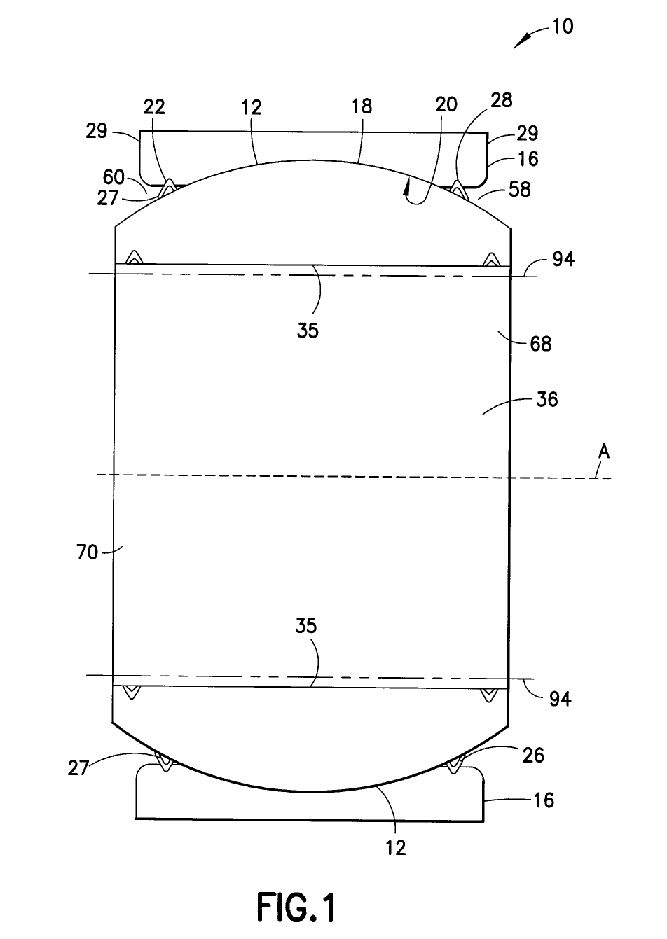

As shown in FIG. 1, a spherical plain bearing is designated generally by the reference number 10 and is hereinafter referred to as “bearing 10.” Bearing 10 includes an inner ring 12 and an outer ring 16. The inner ring 12 has an annular configuration that defines a central axis and has a spherical convex bearing surface 18. The inner ring 12 also has an interior peripheral surface 35 that defines a bore 36 that extends through the inner ring. The bore 36 includes a first opening 68 at one end thereof and a second opening 70 at an opposite end thereof. The outer ring 16 has an annular configuration that also defines a central axis. The outer ring 16 has a spherical concave bearing surface 20 and is open at a first axial end 58 and a second axial end 60. The outer ring 16 and the inner ring 12 are through hardened. When the bearing 10 is assembled, the spherical convex bearing surface 18 and the spherical concave bearing surface 20 reside in interfacial engagement with one another, and the central axes of both the inner ring 12 and the outer ring 16 are coaxial with one another to define a central axis A.

A lubricant can be provided at a load zone of the bearing 10, namely, at the interfacially engaged surfaces of the spherical convex bearing surface 18 and the spherical concave bearing surface 20. This lubricant is selected and applied in sufficient amount to minimize wear, enhance rotational characteristics, and decrease rotational friction with regard to the bearing 10.

The outer ring 16 includes first and second outer ring seals, 26 and 27, respectively, that extend circumferentially around the outer ring. In one embodiment, the first outer ring seal 26 is located proximate the first axial end 58, and the second outer ring seal 27 is located proximate the second axial end 60. Each outer ring seal, 26 and 27, is seated in a seal mounting groove 22 that extends peripherally around the outer ring 16. These outer seal mounting grooves 22 are located inward of the openings at the axial ends of the outer ring 16, namely, spaced some distance from the outer peripheral edges of the bore 36. In the assembled bearing 10, the first and second outer ring seals 26 and 27, respectively, are in spherical engagement with the spherical convex bearing surface 18 of the inner ring 12 and the spherical concave bearing surface 20 of the outer ring. When first and second outer ring seals, 26 and 27, are used, they retain lubricant between the outer rings seals and at the interface of the spherical convex bearing surface 18 and the spherical concave bearing surface 20.

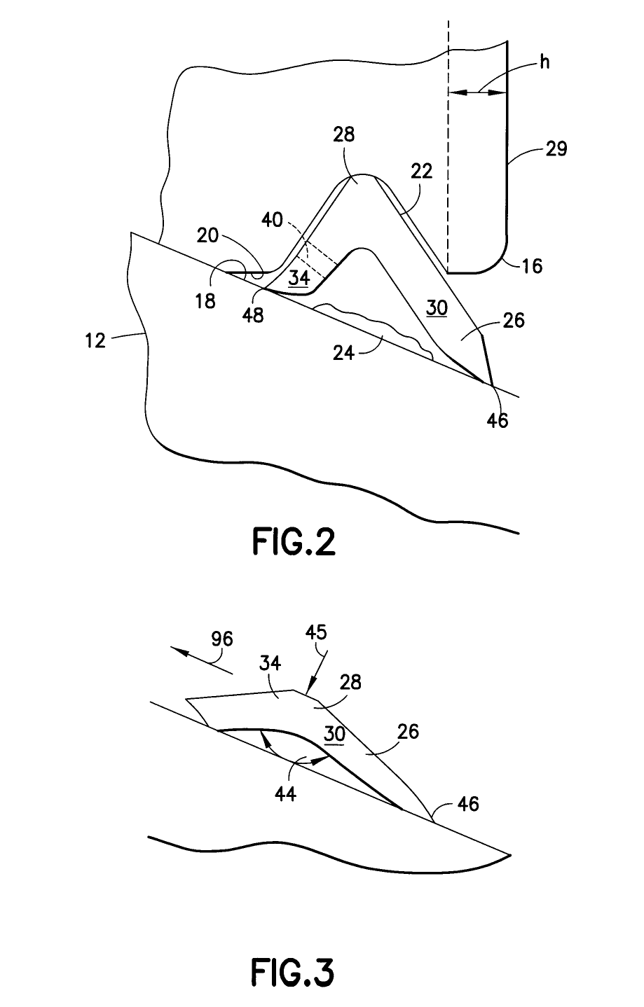

As is shown in FIG. 2, the seal mounting grooves 22 are located inward of an outer face 29 of the outer ring 16 by a distance h. Although the distance h is disclosed as being the same distance for the seal mounting grooves 22 at each end of the outer ring 16, the present invention is not limited in this regard, and the seal mounting grooves may be located at different distances from each end of the outer ring. The first and second ring seals, 26 and 27, respectively, each include a seal base member 28 that is configured to be matingly received in the respective seal mounting groove 22 of the outer ring 16. Each of the first and second ring seals, 26 and 27, respectively, outer ring seal 26 also includes sealing members in the form of an outer lip 30 and an inner lip 34, each of which extend from the seal base member 28 to define a ring having a substantially v-shaped cross-sectional geometry. As shown, the inner lip 34 is shorter than the outer lip 30. In the assembled bearing, the inner lip 34 and the outer lip 30 are each spread away from the other and urged against the spherical convex bearing surface 18 of the inner ring 12. Also, both the inner lip 34 and the outer lip 30 provide the same or similar amounts of pressure on the spherical convex bearing surface 18.

In one embodiment, the first and second ring seals 26 and 27, respectively, may additionally include one or more lubrication holes 40 that extend through the inner lip 34. These lubrication holes 40 allow the lubricant to flow from the area of interfacial engagement of the spherical convex bearing surface 18 and the spherical concave bearing surface 20 to the area located between the inner lip 34 and the outer lip 30. The flow of lubricant (shown at 24) to this area further enhances the operation of the bearing 10.

Sealing communication between the inner lip 34 and the outer lip 30 with the spherical convex bearing surface 18 is generally effected by edges of the inner and outer lips 34 and 30, respectively. The innermost edge (relative to the assembled bearing 10) of the inner lip 34 includes an inner edge 48. The outermost edge of the outer lip 30 also includes an outer edge 46. Both the inner edge 48 and the outer edge 46 facilitate wiping contact with the spherical convex bearing surface 18, thereby maintaining suitable amounts of the lubricant 24 both at the load zone as well as in the area between the inner lip 34 and the outer lip 30.

As is shown in FIG. 3, the flexible resilience of the outer ring seal 26 allows it to be inserted into the seal mounting groove 22. When compressed in the direction of an arrow 45 at the seal base member 28, the outer ring seal 26 is deformed such that the inner lip 34 and the outer lip 30 are urged in opposite directions and outward. When the inner lip 34 and the outer lip 30 are urged outward, an angle 44 is formed therebetween. The outer ring seal 26 can then be moved in the direction of an arrow 96 along the spherical convex bearing surface 18 of the inner ring 12 and under the edge of the outer ring 16. Once appropriately located, the compression (arrow 45) can be released, and the outer ring seal 26 will “snap” into place in the seal mounting groove 22. Compressing the outer ring seal 26 as well as moving the outer ring seal in the direction of the arrow 96 can be affected manually or via the use of automatic mechanisms.

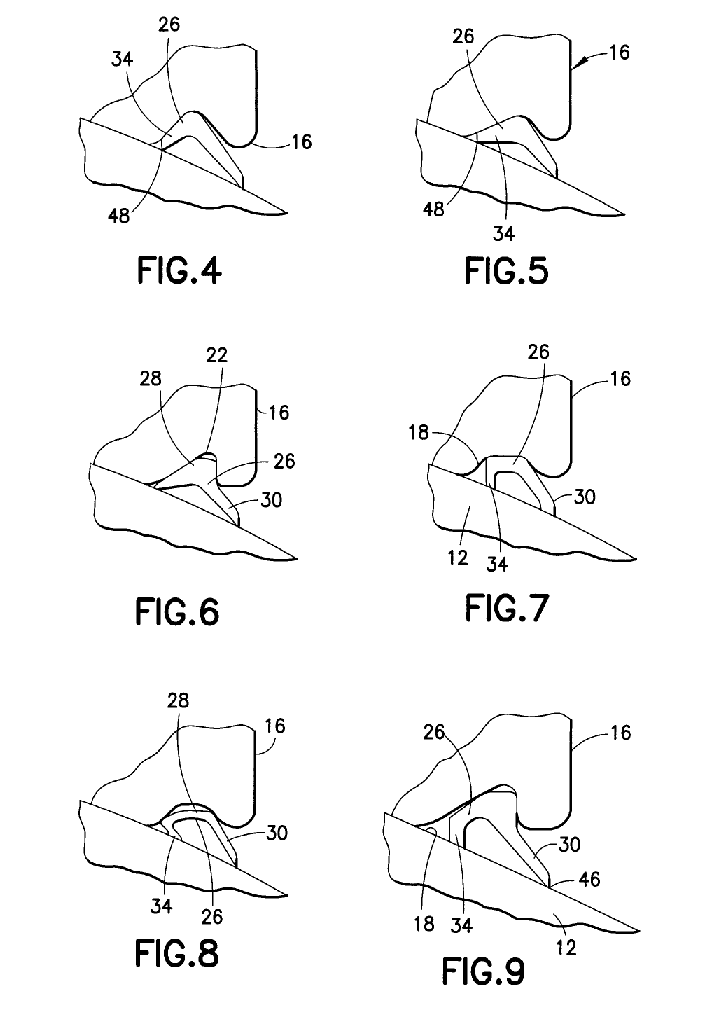

The outer ring seal 26, as is shown in FIGS. 1 and 2, includes a longer outer lip 30 and a shorter inner lip 34. The configurations of these two lips enable the outer ring seal 26 to flexibly accommodate the spherical convex bearing surface 18 of the inner ring 12 and to provide a suitable wiping function for the lubricant. As is shown in FIGS. 4-9, however, the outer ring seal 26 may be configured otherwise. In FIG. 4, the inner lip 34 includes a squared edge 48. In FIG. 5, the inner lip 34 includes a rounded edge 48. In FIG. 6, the seal base member 28 is offset in the direction of the outer lip 30 to provide a surface that can be more positively retained in the seal mounting groove 22 in the outer ring 16. In FIG. 7, the outer ring seal 26 has an angular cross-sectional geometry and instead of sharp edges on the inner lip 34 and the outer lip 30, the inner lip and the outer lip each have flat surfaces that engage the spherical convex bearing surface 18 of the inner ring 12. In FIG. 8, the inner lip 34 is angled outward and in the same direction as the outer lip 30. The seal base member 28 is configured accordingly and may be elongated (widened) to provide a suitable surface area from which both the inner lip 34 and the outer lip 30 can depend. In FIG. 9, the outer ring seal 26 again has an angular cross-sectional geometry, but the outer lip 30 has a sharp edge 46 that contacts the spherical convex bearing surface 18 of the inner ring 12 whereas the inner lip 34 has a flat surface that engages the spherical convex bearing surface. In any of the foregoing embodiments, however, the outer ring seal 26 is located inward of the outer edge of the outer ring 16.

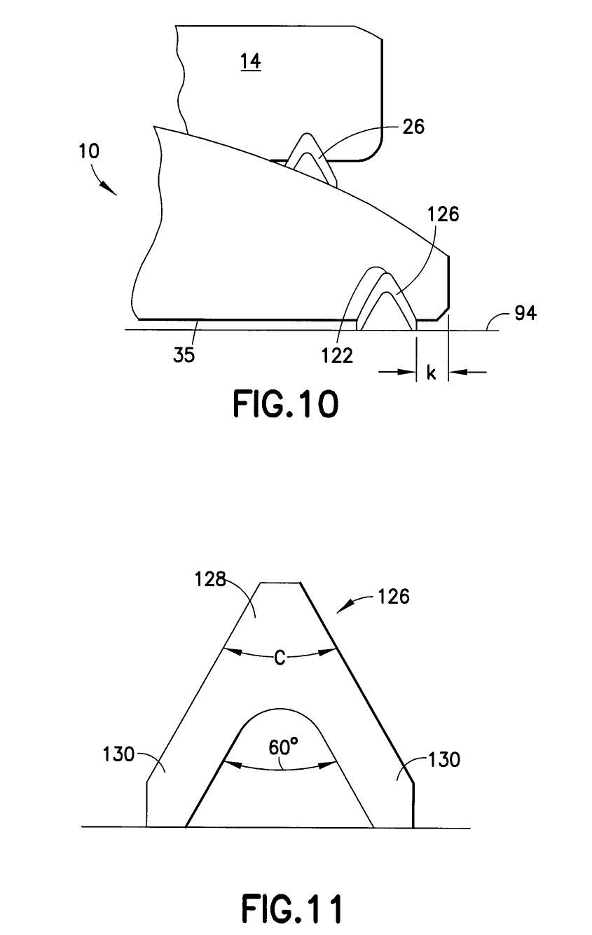

Referring back to FIG. 1, a sealing arrangement similar to the above-described arrangement can be used to provide a seal between the inner ring 12 and a member 94 located in the inner ring. The member 94 may be a shaft or the like, and it may be stationary or rotatable within the inner ring 12. Referring now to both FIGS. 1 and 10, the inner ring 12 includes inner ring seals 126 that extend around the edges thereof proximate the first opening 68 and the second opening 70 defined by the bore 36. Preferably, one inner ring seal 126 is located at the first opening 68, and another inner ring seal is located at the second opening 70.

Each inner ring seal 126 is seated in a seal mounting groove 122. These seal mounting grooves 122 are located inward of the first opening 68 and the second opening 70 of the bore 36 by a distance k. Although the distance k is disclosed as being the same distance for the seal mounting groove 122 at each of the first opening 68 and the second opening 70, the present invention is not limited in this regard, and the seal mounting grooves located at each end of the bore 36 may be located at different distances from the edges of the bore.

During operation, the inner ring seals 126 maintain the member 94 and the interior peripheral surface 35 in sealing engagement, thereby retaining any lubricant at the interface of the interior mounting surface and the movable member between the inner ring seals 126 at the opposing ends of the bore 36 and further preventing or at least limiting the introduction of moisture, debris, or contaminating elements into the bearing 10.

As is shown in FIG. 11, the inner ring seal 126 includes a seal base member 128 that is configured to be matingly received in the inner ring seal mounting groove 122 (FIG. 10). Two lips 130 extend from the seal base member 128 to define the ring structure of the inner ring seal 126 as having a substantially v-shaped cross-sectional geometry. As shown, both lips 130 are substantially the same size and extend from the seal base member 128 at substantially the same angle c to provide similar amounts of pressure on the surface of the member 94 located within the bearing. The ends of the lips 130 are flat. The present invention is not limited to flat-ended lips, however, as other configurations (e.g., rounded, ridges extending in the direction of rotation or movement of the member positioned in the inner ring, and the like) are within the scope of the present invention.

In any of the above-described embodiments, the mating surfaces of the spherical plain bearing 10 may be treated to increase the useful life of the bearing in combination with the lubricant and/or any other lubrication means. For example, either one or both of the mutually sliding surfaces of a metallic spherical plain bearing may be treated to increase their hardness, i.e., the outer ring 16 and the inner ring 12 may be case hardened (also referred to herein as “heat treated”). Suitable case-hardening surface treatments include carburizing, which is the diffusion of carbon into the surface of a metal. The present invention is not limited to carburizing, however, as other processes such as nitriding, carbonitriding, and nitrocarburizing are equally applicable and within the scope of the present invention. When carburizing or any other metal treating process is used in combination with a lubricant as described herein, the case hardened surfaces may be employed in environments in which surface-treated bearings would not otherwise be used.

Another feature that is useful for retaining lubricant on a bearing surface is a lubrication groove, which may be formed on a bearing surface in the load zone (i.e., on the spherical convex or spherical concave bearing surfaces) or on the interior surface of the inner ring (to face the shaft or other member on which the bearing is mounted). The lubrication groove may have contoured sides that have a reduced tendency to wipe lubricant from a facing bearing surface, relative to a lubrication groove having a sharp edge, as in the prior art. Each side of a contoured groove may be rounded to smoothly blend the interior surface of the groove with the bearing surface, i.e., to meet the first bearing surface in a substantially tangential manner. In this way, the tendency of a sharp edge to wipe lubricant from an opposing second bearing surface that faces the first surface is ameliorated. The side edges may be rounded to conform, in cross-section, to a convex curvature that meets the first bearing surface in a substantially tangential manner, such that the groove surface is substantially blended into the bearing surface.

A segmented lubrication groove is one that comprises a first linear portion and a second linear portion that is in fluid communication with, and that extends transversely to, the first linear portion. By being in fluid communication, fluid lubricant that is in the first linear portion of the lubrication groove can easily flow to the second linear portion without having to traverse the bearing surface. Segmented configurations include those that are cruciate, i.e., those in which a second linear portion intersects the first linear portion; those that are T-shaped; and those that merely define angles between two straight portions of the groove. In various embodiments, a cruciate lubrication groove may comprise a plurality of portions that are in fluid communication with, and that extend transversely to, a first linear portion. A segmented lubrication groove allows lubricant to be delivered directly to the mating surfaces of the bearing members over a much greater surface area while the bearing is in use, relative to a conventional, simply linear lubrication groove.

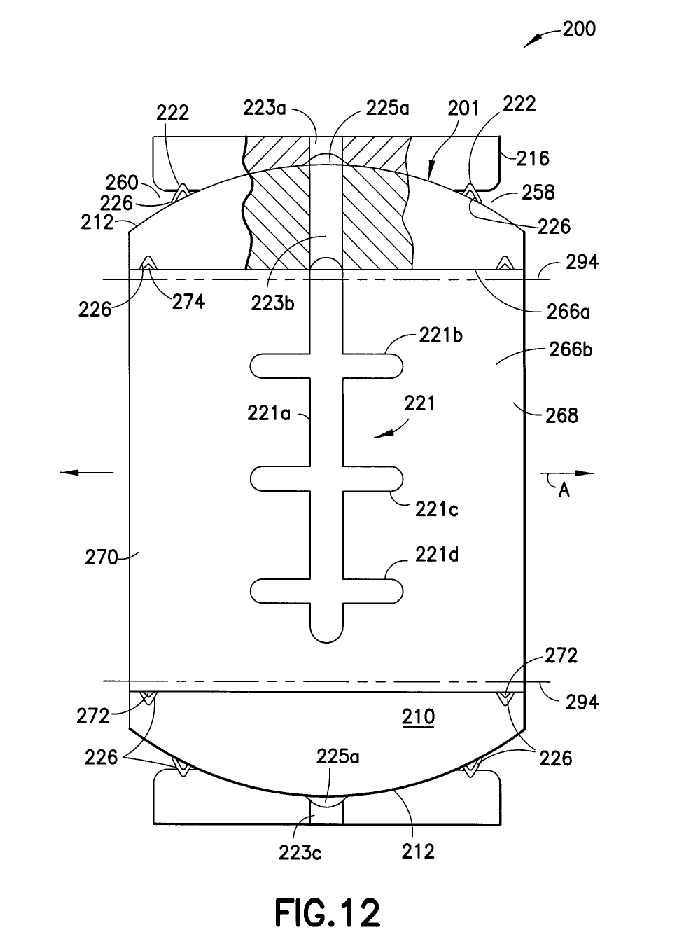

The bearing 200 shown in FIG. 12 is a spherical plain bearing comprising a first bearing member provided by an inner ring 210 and a second bearing member provided by an outer ring 216. The outer ring 216 has an annular configuration with a central axis A and a spherical concave bearing surface 220 that faces the central axis and is open at axial ends 258, 260. The spherical concave surface 220 has a lubrication groove 225a formed therein as shown in FIG. 14. The inner ring 210 is disposed within the outer ring 216, and the inner ring has an annular configuration and has a spherical convex bearing surface 212 that engages the spherical concave bearing surface 220. There are lubrication supply apertures 223a, 223c in the outer ring 216 for providing lubricant to the load zone at the interface of the bearing surface 220 and the bearing surface 212. The lubrication supply apertures communicate with the lubrication grooves in the bearing surfaces described below.

The inner ring 210 has an interior mounting surface 266a that defines a passage 266b (FIG. 12) extending therethrough and a central axis therein. The passage 266b defines a first inner ring opening 268 at one end thereof and a second inner ring opening 270 at the opposite end thereof.

The interior mounting surface 266a of the inner ring 210 has a segmented lubrication groove 221 (seen in FIG. 12) formed therein that is open to the passage 266b. The lubrication groove 221 comprises a generally linear first portion 221a and a generally linear second portion 221b that is in fluid communication with, and disposed in transverse relation to, the first portion 221a. In particular, the second portion 221b intersects first portion 221a. In addition, the lubrication groove 221 comprises optional third and forth portions 221c and 221d, both of which communicate with, and are disposed in transverse relation to, the first portion 221a.

The lubrication groove 221 communicates with the lubricant apertures 223a and 223b in the rings 216 and 210, respectively, through which lubricant may be provided. The lubrication groove 221 serves as a reservoir for lubricant thus provided to lubricate interior mounting surface 266a and a mounted member in inner ring 210 to reduce wear, enhance rotational characteristics and decrease rotational friction of the mounted member in the bearing.

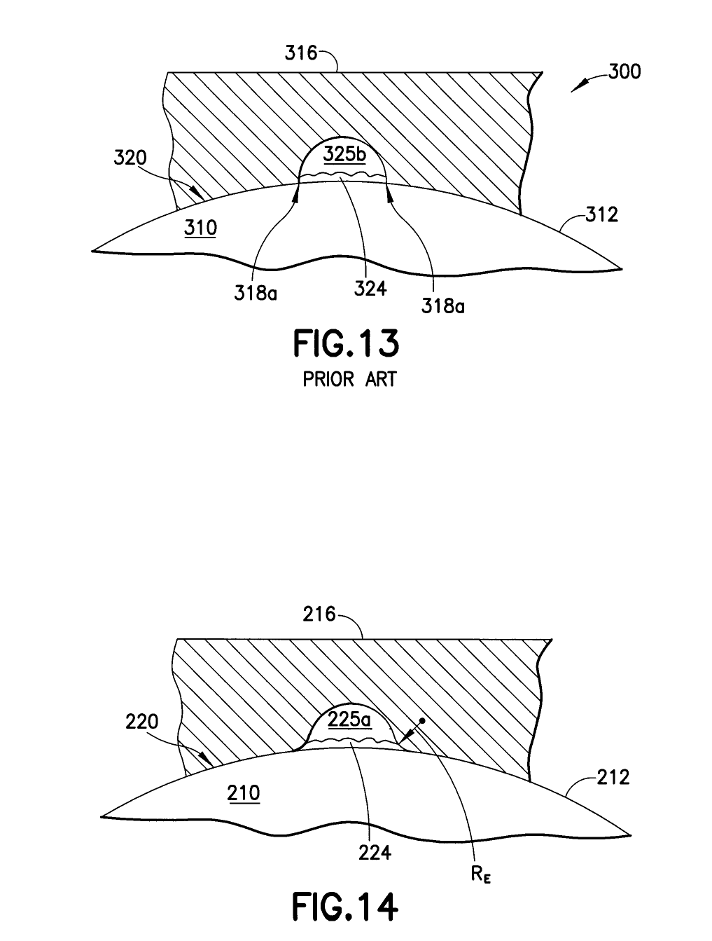

As shown in FIG. 13, a bearing 300 has a prior art lubrication groove 325b that has a conventional configuration, i.e., it is substantially linear and comprises sharp edges 318a at the bearing surface. The lubrication groove serves as a reservoir for lubricant 224 that is drawn into the interface of the surfaces 312 and 320 as the bearing functions. However, sharp edges tend to wipe lubricant from the surface 312 as the inner ring 310 moves relative to the outer ring 316, thus inhibiting lubricant 324 from lubricating the bearing.

In contrast, the bearing 200 has a lubrication groove 225a that has contoured sides, as seen in FIG. 14. For example, the side may have a rounded cross-sectional profile having an effective radius RE to provide a generally smooth transition between the surface of the lubrication groove 225a and the bearing surface 212. As a result, the groove 225a does not have sharp-edged sides that exhibit the wiping tendency of prior art lubrication grooves, and less of the lubricant 224 is wiped off of the surface 212 than would be if the sides defined sharp edges. Accordingly, more lubricant remains between the surfaces 212 and 220 during use of the bearing, thus extending the bearing life. A lubrication groove can be provided with a contoured side in various ways. For example, the bearing can be made with a sharp edge as is known in the art, and the sharp edge can be machined down to the desired profile by means of applying a vibratory finish. Alternatively, the contoured side may be achieved by means of a tool cut.

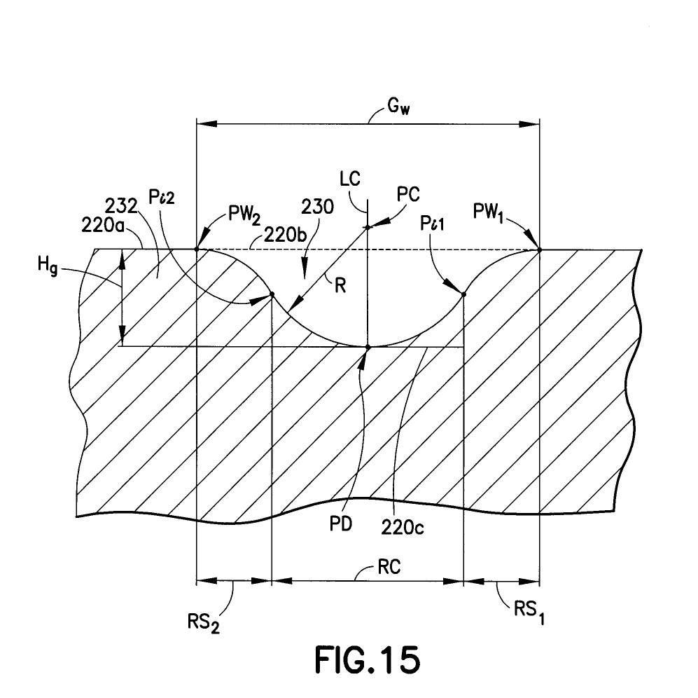

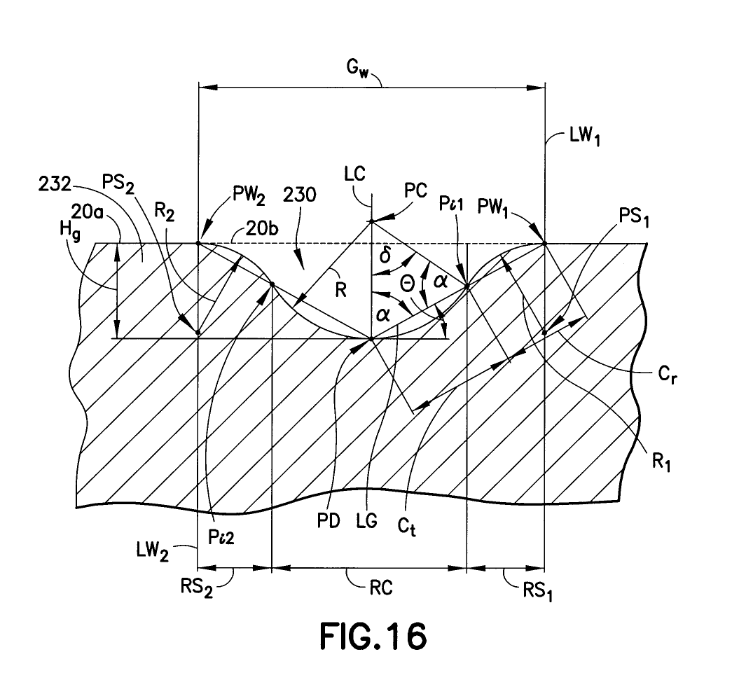

Details of a specific embodiment of a lubrication groove with contoured sides as described herein are disclosed in relation to the groove 230 shown in FIGS. 15 and 16. For ease of illustration, the bearing surface 220a is show as a flat surface on the ring member 232, but it will be understood that the groove 230 will be formed in a spherical surface, and that description of the features of the groove 230 provided herein will pertain nonetheless to an acceptable approximation. The bearing surface 220a may be either a concave bearing surface (on an outer ring) or a convex bearing surface (on an inner ring).

The groove 230 has a nominal finish depth Hg from the adjacent bearing surface 220a to the deepest point PD in the groove 230 measured on a perpendicular from the adjacent bearing surface 220a. The groove 230 also has an overall width Gw, which extends from side point PW1 on the bearing surface to side point PW2, at which points the surface of the groove 230 is machined to tangentially depart towards point PD from the plane 220b of the bearing surface.

The groove 230 has two contoured side regions RS1, RS2 and a central region RC. The central region RC is concave and conforms substantially to a circular arc defined by a central circular radius R. Radius R originates from a point PC that is on a line LC, line LC being perpendicular to the plane of the bearing surface and passing through point PD. In addition, the point PC is offset from the plane of the bearing surface so that R is greater than Hg. The surface of the groove in region RC coincides with a circular sector bounded by points Pi1 and Pi2.

The sides of the groove 230, which are in side regions RS1 and RS2, are machined to be convex and to conform to substantially circular arcs defined by “blend radii” R1 and R2 (FIG. 16), respectively. The blend radii R1, R2 originate from points PS1 and PS2 that are on lines LW1 and LW2, lines LW1 and LW2 being perpendicular to the bearing surface at side points PW1 and PW2. The blend radii R1, R2 are smaller in magnitude than Hg. The arcs of side regions RS1 and RS2 are bounded by points Pi1 and PW1 and points Pi2 and PW2, respectively, and merge substantially tangentially with the bearing surface 220a at points PW1 and PW2. The sides of the groove 230 merge substantially tangentially with the concave groove surface of region RC at transition points Pi1 and Pi2, where the groove surface changes between being concave and convex.

A line LG drawn from the point PD to a point PW1 passes through the transition point Pi1 and defines angle α relative to Line LC and an angle θ (=90°−α) relative to a plane 220c parallel to the plane 220b of the bearing surface. The line LG has a first chord Ct that extends between PD and the Pi1 and a second chord Cr that extends from Pi1 to the nearest side point PW1. Preferably, the blend radii R1 and R2 should be at least equal to, or greater than, the chord Cr. The end points of chord Ct define an angle δ having an apex at PC.

In one illustrative embodiment R is equal to about 0.06 inch, angle α is about 60° and radii R1 and R2 are each equal to about 0.04 inch. In addition, the groove 230 has a width Gw of about 0.175 inch and a groove depth Hg of 0.05 inch.

In another illustrative embodiment R is equal to about 0.05 inch, angle α is about 54° and radii R1 and R2 are each equal to about 0.009 inch. In addition, the groove 230 has a width Gw of about 0.11 inch and a groove depth Hg of 0.04 inch.

In various embodiments, the bearing surfaces of a spherical plain bearing may have one or more lubrication grooves that have sharp edges or contoured sides, or both.

As seen in FIG. 12, the bearing 200 comprises seals 226 in seal mounting grooves 222 at each end 258, 260 of the bearing cavity in the outer ring 216 to help retain lubricant in the and inhibit the entry of contaminants into the bearing load zone. There are also seals 226 in mounting grooves 272 formed in the convex surface of the inner ring 210 adjacent the first and second inner ring openings 268, 270, to provide a seal between the inner ring 210 and a member (such as a shaft) 294 on which the inner ring is mounted. The seals 226 and the grooves 222, 272 in which the seals are seated may be configured as described hereinabove.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A spherical plain bearing with dual sealing capability, said bearing comprising:
an outer ring having a first peripheral edge, an opposing second peripheral edge, and a spherical concave bearing surface extending between said first edge and said second edge;
an inner ring having a bore located therein and a spherical convex bearing surface, said spherical convex bearing surface being located in interfacial sliding engagement with said spherical concave bearing surface;
said outer ring and said inner ring being through hardened;
a first ring seal located in a first seal groove defined by said outer ring; and
a second ring seal located in a second seal groove defined by said outer ring, said first and second ring seals each having a first lip and a second lip connected together to form a substantially v-shaped cross-sectional geometry, said first and second seal grooves each being located inboard of an end face defined by said outer ring, said first lip and said second lip being in sealing engagement with said spherical convex bearing surface, and said spherical convex bearing surface and said spherical concave bearing surface being case hardened.

2. The spherical plain bearing of claim 1, further comprising a lubricant disposed at the location of interfacial sliding engagement of said spherical convex bearing surface and said spherical concave bearing surface.

3. The spherical plain bearing of claim 1, wherein at least one of said inner ring and said outer ring is case hardened using a process selected from the group consisting of carburizing, nitriding, carbonitriding, and nitrocarburizing.

4. The spherical plain bearing of claim 1, further comprising a first inner ring seal located in a surface of said bore and proximate one end of said inner ring.

5. The spherical plain bearing of claim 4, wherein said first inner ring seal has a first lip and a second lip connected together to form a substantially v-shaped cross-sectional geometry and located in said surface of said bore such that said first lip and said second lip can be maintained in dual sealing engagement with a member extending into said bore.

6. The spherical plain bearing of claim 4, further comprising a second inner ring seal located in said surface of said bore and proximate one end of said inner ring.

7. The spherical plain bearing of claim 1, further comprising a lubrication groove in the spherical convex bearing surface, the spherical concave bearing surface, or both, the lubrication groove comprising a contoured side.

8. The spherical plain bearing of claim 7 wherein the lubrication groove has a concave central portion and convex side portions.

9. The spherical plain bearing of claim 8, wherein the convex side portions blend into the bearing surface in which they are disposed.

10. The spherical plain bearing of claim 8, wherein the groove is bounded by side points, and wherein the concave portion meets the convex portions at transition points, and wherein each convex side portion has a radius of curvature that is about equal to the distance from an transition point to the nearest side point, and wherein the radius of curvature emanates from a point on a line that is perpendicular to the bearing surface at the side of the groove.

11. The spherical plain bearing of claim 10, wherein the concave central portion conforms to a second radius of curvature that is greater than the radius of curvature of a side portion, and wherein the second radius of curvature emanates from a point on a line that is perpendicular to the bearing surface at a point at the center of the groove.

12. The spherical plain bearing of claim 11, wherein the groove has a groove depth and the second radius of curvature is greater than the groove depth.

13. The spherical plain bearing of claim 8 wherein the lubrication groove is a segmented lubrication groove.

14. The spherical plain bearing of claim 13, wherein the segmented lubrication groove comprises a first generally linear portion and a second generally linear portion that intersects with the first generally linear portion.

15. The spherical plain bearing of claim 1, wherein the inner ring has an interior mounting surface for engaging a member on which the inner ring is mounted, and a segmented lubrication groove in the interior mounting surface.

16. The bearing of claim 15, wherein the segmented lubrication groove comprises a contoured side.

17. The spherical plain bearing of claim 15 wherein the lubrication groove has a concave central portion and convex side portions.

18. The spherical plain bearing of claim 17, wherein the convex side portions blend into the bearing surface in which they are disposed.

19. The spherical plain bearing of claim 17, wherein the groove is bounded by side points, and wherein the concave portion meets the convex portions at transition points, and wherein each convex side portion has a radius of curvature that is about equal to the distance from an transition point to the nearest side point, and wherein the radius of curvature emanates from a point on a line that is perpendicular to the bearing surface at the side of the groove.

20. The spherical plain bearing of claim 19, wherein the concave central portion conforms to a second radius of curvature that is greater than the radius of curvature of a side portion, and wherein the second radius of curvature emanates from a point on a line that is perpendicular to the bearing surface at a point at the center of the groove.

21. The spherical plain bearing of claim 20, wherein the groove has a groove depth and the second radius of curvature is greater than the groove depth.

22. A spherical plain bearing, comprising:
an inner ring defining a first bore therethrough and having a spherical convex bearing surface on an outer surface thereof;
an outer ring defining a second bore therethrough and having a spherical concave bearing surface on an inner surface thereof, said spherical concave bearing surface being in contact with said spherical convex bearing surface such that said first bore and said second bore register;
said outer ring and said inner ring being through hardened; and
a first sealing member located in said spherical concave bearing surface and extending around a first peripheral edge of said second bore and being positioned distal from said first peripheral edge of said second bore, said first sealing member being in dual sealing communication with said spherical convex bearing surface; and
a second sealing member located in said spherical concave bearing surface and extending around a second peripheral edge of said second bore and being positioned distal from said second peripheral edge of said second bore, said second sealing member being in dual sealing communication with said spherical convex bearing surface;
wherein said inner ring and said outer ring are case hardened.

23. The spherical plain bearing of claim 22, wherein said inner ring and said outer ring are case hardened with a process selected from the group consisting of carburizing, nitriding, carbonitriding, and nitrocarburizing.

24. The spherical plain bearing of claim 22, further comprising a lubricant located between said first sealing member and said second sealing member.

25. The spherical plain bearing of claim 22, further comprising,
a third sealing member located in a defining surface of said first bore and located distal from a first peripheral edge of said first bore, and
a fourth sealing member located in said defining surface of said first bore and located distal from a second peripheral edge of said first bore.

26. The spherical plain bearing of claim 22, wherein said first sealing member located in said spherical concave bearing surface comprises a first lip and a second lip attached to said first lip such that upon assembly of said spherical plain bearing, said dual sealing communication with said spherical convex bearing surface is effected.

27. A spherical plain bearing, comprising:
an inner ring having a first bore extending therethrough, said first bore being defined by openings at opposing ends of said first bore and a surface extending between said openings, and having a spherical convex bearing surface located on an outer surface of said inner ring;
an outer ring mounted in bearing communication with said inner ring, said outer ring having a second bore extending therethrough in which said inner ring is located, said second bore defined by openings at opposing ends of said second bore and a spherical concave bearing surface extending between said openings;
said outer ring and said inner ring being through hardened;
first seal grooves extending peripherally around each of said openings defining said second bore, said first seal grooves being located distally from defining edges of said openings; and
first sealing members located in each of said first seal grooves, each of said first sealing members comprising a ring having a substantially v-shaped cross-sectional configuration, said v-shaped cross-sectional configuration being defined by a first lip connected to a second lip;
wherein upon assembly of said inner ring and said outer ring, said spherical convex bearing surface and said spherical concave bearing surface are interfacially engaged;
wherein upon assembly of said inner ring and said outer ring, said first lip and said second lip are urged apart and provide sealing contact with said spherical convex bearing surface located on said outer surface of said inner ring; and
wherein said inner ring and said outer ring are case hardened.

28. The spherical plain bearing of claim 27, further comprising a lubricant located at the interfacially engaged surfaces of said spherical convex bearing surface and said spherical concave bearing surface.

29. The spherical plain bearing of claim 27, further comprising,
two second seal mounting grooves located in said first bore, each of said second seal mounting grooves being located distally from said defined openings at said opposing ends of said first bore and in said surface thereof, and
second sealing members located in each of said second seal grooves, each of said second sealing members comprising a ring having a substantially v-shaped cross-sectional configuration, said v-shaped cross-sectional configuration being defined by a first lip connected to a second lip.

30. The spherical plain bearing of claim 27, wherein at least a portion of said spherical convex bearing surface and at least a portion of said spherical concave bearing surface is case hardened using a process selected from the group consisting of carburizing, nitriding, carbonitriding, and nitrocarburizing.

31. A bearing assembly, comprising:
a spherical plain bearing, comprising,
an inner ring having a first bore extending therethrough, said first bore being defined by openings at opposing ends of said first bore and a surface extending between said openings, and a spherical convex bearing surface located on an outer surface of said inner ring;
an outer ring mounted in bearing communication with said inner ring, said outer ring having a second bore extending therethrough in which said inner ring is located, said second bore defined by openings at opposing ends of said second bore and a spherical concave bearing surface extending between said openings,
said outer ring and said inner ring being through hardened;
first seal grooves extending peripherally around each of said openings defining said second bore, said first seal grooves being located distally from defining edges of said openings,
first sealing members located in each of said first seal grooves, each of said first sealing members comprising a ring having a substantially v-shaped cross-sectional configuration, said v-shaped cross-sectional configuration being defined by a first lip connected to a second lip; and
a member associated with said spherical plain bearing, said member being located in said first bore;
wherein upon assembly of said inner ring and said outer ring, said spherical convex bearing surface and said spherical concave bearing surface are interfacially engaged;
wherein upon assembly of said inner ring and said outer ring, said first lip and said second lip are urged apart and provide sealing contact with said spherical convex bearing surface located on said outer surface of said inner ring; and
wherein said spherical convex bearing surface and said spherical concave bearing surface are case hardened.

32. The bearing assembly of claim 31, further comprising second sealing members located in said surface of said inner ring.

33. The bearing assembly of claim 32, wherein said second sealing members are located distally from said openings at said opposing ends that define said first bore.

34. The bearing assembly of claim 32, wherein said second sealing members are located in grooves located in said surface of said inner ring.

35. The bearing assembly of claim 31, wherein at least a portion of said interfacially engaged spherical convex bearing surface and said spherical concave bearing surface are hardened using a process selected from the group consisting of carburizing, nitriding, carbonitriding, and nitrocarburizing.
